(19) United States
(12) Patent Application Publication
(10) Pub. No.: US 2016/0009000 A1
(43) Pub. Date: Jan. 14, 2016

(54) Composition and Method of Manufacture of Hardened Wood

(71) Applicant: Brian Matthew Sanderson, Hurricane, UT (US)

(72) Inventor: Brian Matthew Sanderson, Hurricane, UT (US)

(21) Appl. No.: 14/865,716

(22) Filed: Sep. 25, 2015

Related U.S. Application Data
(62) Division of application No. 14/183,824, filed on Feb. 19, 2014.

(51) Int. Cl. B27K 3/02; B27K 3/08; B27K 5/06

(52) U.S. Cl. CPC B27K 3/0207; B27K 5/065; B27K 3/08

(57) ABSTRACT

There is a hardened wood composition, comprising an acetylated whole wood portion that may have substantially all of its accessible interior volume impregnated with a hardened thermosetting plastic. A method of manufacturing a hardened wood comprising the steps of: acetylating a whole wood portion and impregnating the whole wood portion with a liquid-phase thermosetting polymer then curing such thermosetting polymer impregnated porous body by the steps of: enclosing the body in a fluid impermeable bag and subjecting the enclosed body to enhanced fluid pressure substantially, contemporaneously, with subjecting the enclosed body to a temperature sufficient to cure the thermosetting plastic impregnated therein by submerging the same in water near its boiling point.

### CROSS-REFERENCE TO RELATED APPLICATIONS

This application is a Divisional Application of under 35 U.S.C. §121, and claims priority to, under 35 U.S.C. §121, U.S. Non-Provisional application Ser. No. 14/183,824, entitled Composition and Method of Manufacture of Hardened Wood, by Brian Matthew Sanderson, filed on Feb. 19, 2014. This invention also claims priority, under 35 U.S.C. §120, to each of the U.S. Provisional Patent Application Nos. 61/766,573 and 61/766,595 each by Brian Sanderson and each filed on 19 Feb. 2013, which are each incorporated by reference herein in their entireties.

### BACKGROUND OF THE INVENTION

1. Field of the Invention

The present invention relates to hardened wood compositions and methods of manufacture, specifically to wood impregnated by thermoplastics.

2. Description of the Related Art

In the related art, it has been known to use techniques to harden wood and/or otherwise alter its characteristics.

The inventions heretofore known suffer from a number of disadvantages which include allowing water absorption, wood changing in size under various environmental conditions, decay, being subject to mold, being subject to damage by insects, being soft, warping, causing noxious fumes, being dangerous to produce, being difficult to manufacture, having poor consistency in characteristics, etc.

What is needed is a composition and/or method of manufacture that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available compositions and methods of manufacture. Accordingly, the present invention has been developed to provide a hardened wood composition and method of manufacture of the same.

In one non-limiting embodiment, there is a hardened wood composition, comprising an acetylated whole wood portion that may have substantially all of its accessible interior volume impregnated with a hardened thermosetting plastic.

In another non-limiting embodiment, there is a method of manufacturing a hardened wood comprising one or more of the steps of: acetylating a whole wood portion and impregnating the whole wood portion with a liquid-phase thermosetting polymer.

In still another non-limiting embodiment, there is a method of curing a thermosetting polymer impregnated porous body comprising one or more of the steps of enclosing the body in a fluid impermeable membrane and subjecting the enclosed body to enhanced (compared to pressure interior to the membrane) fluid pressure substantially, perhaps contemporaneously, with subjecting the enclosed body to a temperature sufficient to cure the thermosetting plastic impregnated therein. It may be that the membrane is a plastic bag. It may be that the fluid pressure and/or temperature is applied by submerging the enclosed body in water near but below boiling temperature.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). it is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 illustrates porous wood structure, according to one embodiment of invention;

FIG. 2 illustrates an impregnation container and a plurality of the same stacked in an array in a vacuum chamber, according to one embodiment of the invention;

FIG. 3 illustrates a cured block of wood with substantial seepage of resin therefrom, according to one embodiment of the invention;

FIG. 4 illustrates a curing tank and associated curing package, according to one embodiment of the invention;

FIG. 5 is a flowchart of a method of manufacturing hardened wood, according to one embodiment of the invention; and

FIG. 6 illustrates a method of curing an impregnated body, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant an and having possession of this disclosure, are to be considered within the scope of the invention.

Reference throughout this specification to an “embodiment,” an “example” or language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting, of” and “consisting essentially of.”

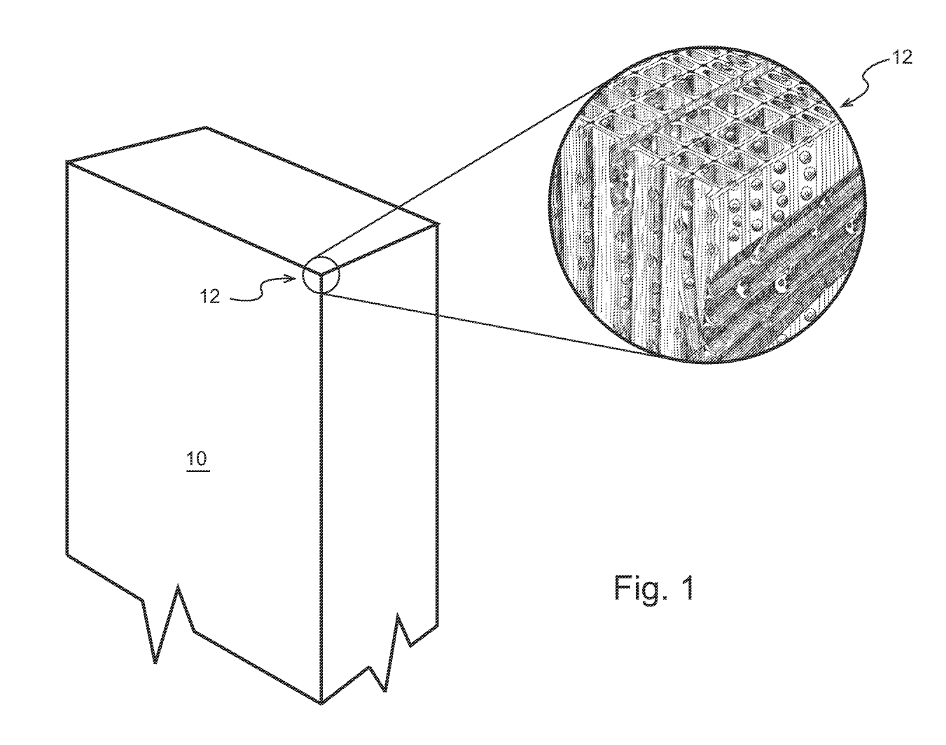

FIG. 1 illustrates, conceptually, porous wood structure, according to one embodiment of the invention. There is shown a corner 12 of a block 10 of porous wood with an exaggerated close up view of the corner of the same showing channel and pore structure of the same.

In particular, many varieties of wood, including but not limited to pine, oak, include cells configured to channel fluids through the wood for the benefit of the tree. These channels persist even after the wood is cut and essentially dead. The channels include pores therebetween which allow for fluid to transfer from channel to channel. There are at least two types of cells or “channels” and are of different sizes and lengths from species to species. Specifically, these are commonly known as:

1. Tracheids: narrower/shorter cells; and

2. Vessels: wider/longer cells.

Conifer trees (such as but not limited to varieties of pine) generally only have tracheids, and angiosperm trees (such as but not limited to varieties of oak) have both tracheids and vessels. The tracheids and vessels all generally narrow down to a conical tip at each end, and the cells are in a somewhat staggered arrangement.

The channels include other pore or valve-like structures (commonly known as “bordered pits” and, in the case of vessels, also, tyloses), which shall be referred to commonly herein as “pores.” These pores serve various functions to the living wood, such as but not limited to controlling the flow of fluids between adjacent channels. In cut wood, the pore structure operates to inhibit the flow of fluids between channels. Various wood types will inhibit fluid flow therethrough when cut and dried to varying degrees, it is believed, mostly due to the structure of the channels and most specifically due to pore structure. Dead wood will absorb moisture from the air and from adjacent fluids through the channels and such will penetrate into the core of the wood by flow of that fluid through the pores (bordered pits and/or tyloses).

There are various processes for treating dead wood that use the pores to beneficial effect, including but not limited to treatments with stains, chromated copper arsenate (CCA), alkaline copper quarternary (ACQ), copper azole treatments, PTI wood preservatives, wax stabilization, borate preservatives, potassium silicate preservatives, bifenthrin spray preservatives, fire retardants, oil-borne preservatives, coal-tar creosote, linseed oil, light organic solvent preservatives (LOSP), wood acetylation, clear penetrating epoxy sealer (CPES), and tung oil, which treatments generally provide beneficial protection against rot, fungus, molds, insects, etc. Sometimes small incisions are cut into the wood to help such materials penetrate deeper/faster/more consistently into the wood during such treatment processes.

With regard to wood acetylation, natural wood contains chemical groups called free hydroxyls (simply OH groups attached to various molecules of the wood in various locations that are chemically available). These free hydroxyls absorb and release water according to changes in the environmental conditions near the free hydroxyls. As the water is absorbed/released, the molecules with the free hydroxyls change in size/shape. This is why wood swells and shrinks based on the water content of the wood.

Wood acetylation effectively alters the free hydroxyls within the wood into acetyl groups. These acetyl groups do not react with water in the same way. This change is accomplished by reacting the wood with acetic anhydride, which is derived from acetic acid (found in vinegar). After the free hydroxyl group is transformed to an acetyl group, the ability of the wood to absorb water is greatly reduced, giving the wood significantly more dimensional stability. Wood species that are optimal for this treatment have an open and free-flowing cell structure; also, these species are typically structurally soft.

The acetylation process does little to harden the wood, and therefore the acetylated wood is still restricted in its application, making it unsuitable for products that require a harder material. Furthermore, the wood acetylation process appears to open the pores of the wood (or otherwise substantially increase fluid penetration through the wood), making the same substantially more porous and prone to penetration of fluids. Because of the increased open cell structure and softness of the wood, the surface of the wood will more easily absorb dirt, oil and other contaminates, thus becoming visually unappealing if not treated with a topical sealant. Further, such sealants tend to be absorbed more quickly and deeply and thus are not as effective as compared to their use with untreated wood. A non-limiting example of acetylated wood is acetylated wood sold under the brand Perennial Wood by Eastman of Kingsport, Tenn.

Soft woods (e.g. beech, alder, white oak, pine, etc.) are sometimes treated with a hardening process to enhance their effective strength. One such technique is to treat the wood with a hardening material, such as but not limited to liquid thermoset sealants/resin/polymer/prepolymer and/or a thermoplastic, such as but not limited to vinyl monomers or similar monomers, modified vinyl monomers and polar monomers (e.g. furfuryl alcohol).

Some examples of vinyl monomers are: vinyl chloride, vinyl acetate, acrylonitrile, ethylene oxide, acrylates (especially methyl methacrylate), t-butyl styrene, styrene and chlorostyrene. Vinyl type monomers may be polymerized into a solid polymer by means of heat, radiation, or heat-catalyst polymerization.

Some examples of thermosetting polymerizable substances include but are not limited to methacrylate esters and diesters, phenol formaldehyde, urea formaldehyde, melamine formaldehyde products, polyurethanes, epoxides, silicones, and unsaturated polyesters. Phenol-formaldehyde resin is located mostly in the cell wall of wood and yields dimensionally stable composites.

Such substances are generally cured by application of energy to the material such as but not limited to by radiation curing, catalyst curing, micro-wave heating, radio-frequency heating, and/or even baking the materials in an oven. This heating hardens the polymer material inside the wood structure and thereby provides enhanced strength from the cross-linked polymers formed inside the interior of the channels of the wood. The process also increases the resistance of the wood to fluid penetration and to attack by insects, molds, etc., though the protection is merely a slowing effect since the effect is caused by physically blocking the channels. The current state of the art believes that there is no meaningful interaction between the cured polymers impregnated into the wood and the hydroxyl groups of the wood molecules, as such impregnated wood remains dimensionally instable through exposure to moisture.

In operation, the liquid thermoset sealant is impregnated into the open cell structure of the wood by use of vacuum and/or pressure. Wherein a vacuum is pulled about the wood, air entrapped therein leaves, which facilitates the impregnation of the wood with the liquid thermoset sealant, as the wood, once the vacuum is reduced/released draws in the liquid (as the gas has escaped the vicinity of the wood since being released). The impregnated wood is then heated to cure the sealant, which hardens into plastic inside the channels.

Heat curing requires that the treated wood be exposed to heat over the curing temperature of the thermoset sealant for a time sufficient to cause that same heat to penetrate the wood and cross-link the polymers inside the body of the treated wood. This time will depend on the physical characteristics of the treated wood, the sealant used and the efficacy of the curing oven. Heating the wood too quickly or at too high a temperature risks cracking, splitting, and/or charring the wood. Accordingly, the process must be done at a pace slow enough and at a low enough temperature to prevent such undesired outcomes, but at a high enough temperature to effectuate curing and fast enough to substantially slow/stop the impregnating fluid from escaping before curing.

Wherein impregnated wood is heat cured in an oven, thermosetting material may bleed out into the oven and may come into contact with super-heated surfaces therein. This generally results in outgassing of noxious materials (vaporized materials and/or combustion by-products) from the thermosetting material, which can be hazardous and certainly interferes with efficient and cost effective operations. The more bleeding which is likely to occur, the higher likelihood of such outgassing and the greater the volume of the same if it occurs.

The various treatments each add to the cost of the treated wood. This has been a major difficulty in the development of wood treatments and has played a central role in the delayed implementation and sometimes the abandonment altogether of various treatments. As a non-limiting example, wood acetylation is a hundred-year old technology, but has had great difficulty in achieving market acceptance as wood treated by acetylation may cost three to five times the cost of untreated wood. Accordingly, the extra costs may not be recovered until the wood would have had to be replaced five or more times. This may result in an expense that is not justified until fifteen to thirty years after the initial investment is made. It is rare for an investor to expect to hold onto a property for that long and therefore rare for such an investor to be inclined to that investment.

In particular, wood is usually seen by the market as a fungible commodity and, therefore the market is very price sensitive, especially in the construction industry where high bids on projects rarely win. Further, the various treatments are not generally compatible with each other. Various chemicals used in these treatments may react adversely to each other and/or may undo or restructure critical structures generated in one treatment. Further, combinations of treatments may be less efficacious than the sum of their benefits and/or may be more expensive than the sum of their separate expenses. Such combinations will tend to only provide marginal extra benefits while increasing total costs exponentially. Accordingly, if wood is treated at all (it is often not), a single treatment is selected, or a penetrating treatment is used in combination with a surface treatment (sealing, staining, painting, etc.) as the surface treatment may be applied second and physically overlap the penetrating treatment.

In one non-limiting embodiment, there is a hardened wood composition, comprising an acetylated whole wood portion (wood having substantially throughout its interior structure acetyl groups in place of hydroxyl groups to a degree generally experienced in wood said to be acetylated wood) that may have substantially all of its accessible interior volume impregnated with a hardened thermosetting plastic, such as but not limited to one or more of the thermosetting polymers/pre-polymers described herein. The hardened wood composition is substantially free of splitting, cracking, charring and other heat-induces flaws. It is believed that the hardened thermosetting plastic interacts with the acetyl groups (which replaced the hydroxyl groups) in a beneficial manner, thereby providing enhanced benefit, characteristic(s), operating properties, manufacturing benefits, and the like and combinations thereof. Such an interaction may include chemical and/or physical interactions that may impact one or more of the following properties/characteristics: hardness, compression strength, fluid impermeability, resistance to organisms (fungi, mold, bacteria, insects, etc.), manufacture speed, quality consistency, dimensional stability, weight stability, electrical resistance, and the like and combinations thereof.

Further, the hardened wood composition is substantially fully impregnated (having substantially all of its accessible interior volume impregnated with a hardened thermosetting plastic) with greater than about one of 85%, 86%, 87%, 88%, 89%, 90%, 91%, 92%, 93%, 94%, 95%, 96%, 97%, 98%, 99%, 99.5%, 99.9%, and 99.99% (conversely, empty volume/weight may be less than about one or 15%, 14%, 13%, 12%, 11%, 10%, 9%, 8%, 7%, 6%, 5%, 4%, 3%, 2%, 1%, 0.5%, 0.1%, and 0.01%) of the maximum volume and/or weight of reasonably possible impregnation being achieved. Such may be measured by weighing the wood pre-impregnation, substantially fully impregnating the wood (generally using vacuum and/or pressure techniques), measuring the weight of the fully impregnated wood, and then measuring the weight of impregnation material that escapes the wood during the curing process. A similar measurement may be made using volume, wherein a total absorbed volume is measured/calculated/determined and then compared to a volume of material that escapes during the curing process.

This quality of hardened wood is very difficult to achieve in practice. Further, each of the processes significantly increase the cost of the wood so treated in a manner that is more than the sum of the expenses, since the two processes interact in a manner that frustrates the purposes of the same. In particular, curing speeds and temperatures are limited to those which will not cause cracking, splitting and/or charring. This fact of the process is aggravated in combination with the pore “opening” effect caused by the wood acetylation process, which speeds the rate at which fluid flows both into and out of the body of wood.

Accordingly, wherein acetylation precedes the impregnation process, the impregnation phase is quickened (the material penetrates fully into the wood more quickly) but the escape is also quickened. Accordingly, applicant has observed very substantial “bleeding” (escape) of thermosetting material from acetylated wood during usual curing processes. Wherein substantial bleeding of material occurs during the curing process, the hardened wood is not consistently impregnated with hardened polymer and therefore has weak regions that will vary in the desired characteristics. Accordingly, to achieve consistently treated wood, one would likely have to use expensive internal imaging procedures to find and excise portions of wood not fully impregnated, thus losing substantial material in the process and severely increasing total costs of the final wood. If the curing process is intensified to quicken the hardening of the thermosetting fluid, the wood experiences damage from the heat. Thus Applicant believes that a combination of the processes described above has not heretofore been attempted as failure of the combination is virtually guaranteed. Accordingly, Applicant believes that the hardened wood composition described above has not heretofore existed.

However, using the method(s) described herein, Applicant has been able to achieve the very high quality hardened wood described herein, without the very expensive means that one would expect to have to resort to achieve the same. In a non-limiting embodiment, there is a method of manufacturing a hardened wood comprising the steps of: acetylating a whole wood portion and impregnating the whole wood portion with a liquid-phase thermosetting material, such as but not limited to methacrylate esters and diesters and/or other thermosetting materials described herein, wherein the impregnating step includes a method of curing a thermosetting material impregnated porous body (the acetylated whole wood portion) comprising one or more of the steps of enclosing the body in a fluid impermeable membrane and subjecting the enclosed body to enhanced (as compared to pressure interior to the membrane) fluid pressure substantially, contemporaneously, with subjecting the enclosed body to a temperature sufficient to cure the thermosetting plastic impregnated therein.

Generally the membrane is a bag constructed of a material that retains substantially all of its fluid impermeable nature with regard to fluids used in the process when exposed to the temperatures of the process. Non-limiting examples of materials Applicant has found to be suitable include but are not limited to silicone, rubber, neoprene and Biaxially-oriented polyethylene terephthalate (sold under the brand Mylar), when used with water as a fluid providing fluid pressure and a thermosetting material which may be cured at temperatures below the boiling point of water. It has been observed that some membranes, even of some plastics at certain thicknesses, allow steam to enter, thereby undesirably exposing the curing material to water. In such a non-limiting case, the fluid pressure and temperature is applied by submerging the enclosed body in water near but below the boiling temperature of water (e.g. ˜160-210 degrees Fahrenheit for curing of methacrylate esters and diesters). Further, after acetylating the wood and before impregnating the same, the wood is generally allowed to dry until moisture content is less than about 10-12%. Wherein the wood is acetylated in a facility with low humidity, this drying process may occur naturally over time. Wherein the wood is present in an environment with substantial humidity, the wood may need to be exposed to dryer air or subjected to a baking process to bake off the excess moisture. Moisture content may be measured by weight comparisons and/or by using a moisture meter such as but not limited to the Seeker Pinless Moisture Meter UX-37803-82 by General Tools of New York, N.Y. (or even a multimeter to calculate it by measuring the resistance through the wood).

Advantageously, utilizing the above described process, the hardened wood composition is created in faster time (as the more opened pore structure quickens the impregnation process and the “fluid baking” results in a faster cure time, as fluids have a higher heat capacity), and results in wood having both increased hardness and greater stability. Such a wood may be utilized for many different purposes, including but not limited to the construction of decks, fences, vehicle parts, flooring, musical instruments, jewelry, mechanical parts, tools, etc. and parts/portions thereof wherein dimensional stability and strength are desired properties.

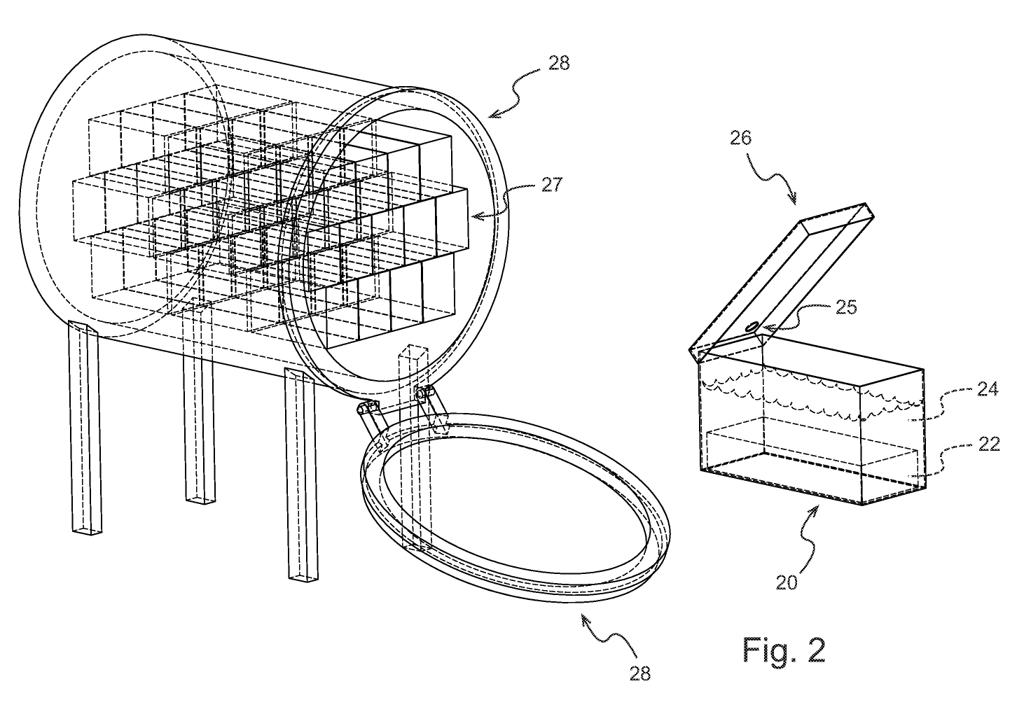

FIG. 2 illustrates an impregnation container and a plurality of the same stacked in an array in a vacuum chamber, according to one embodiment of the invention. There is shown a vacuum chamber 28 including a stacked array 27 of impregnation containers 20, such that a plurality of wood blocks 22 may be impregnated simultaneously, but separately.

The illustrated impregnation container 20 includes a hinged lid 26 having an aperture 25 therethrough such that when the impregnation container 20 is exposed to a vacuum, the vacuum pressure is also experienced inside the impregnation box. The illustrated impregnation container 20 includes a fluid 24, which includes a thermosetting material intended to be impregnated into the wood block.

Advantageously, such a vacuum chamber 28, with its stacked array 27 of impregnation boxes allows for inclusion of a variety of dyes into each of the separate impregnation boxes. This permits impregnation of different colors into the wood blocks during a single impregnation process using a single vacuum chamber.

In particular, each container 20 may be loaded with a block 22 and fluid 24 and then dyes and/or other additives may be added thereto on a container by container basis. This allows for more rapid generation of customized impregnated wood portions.

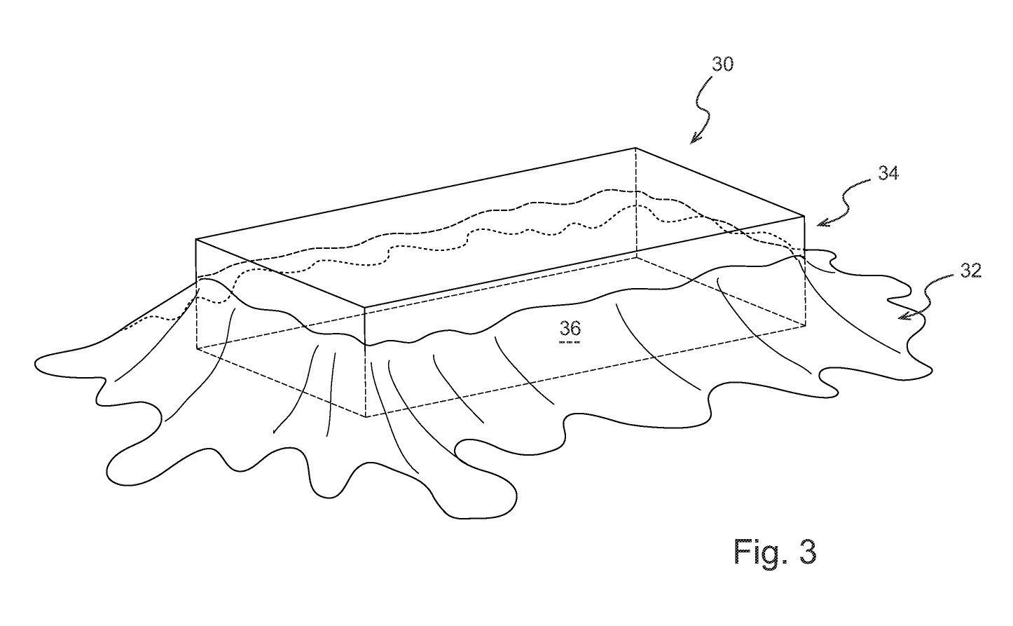

FIG. 3 illustrates a cured block of wood with substantial seepage of resin therefrom, according to one embodiment of the invention. There is shown a composite structure 30 of a cured block 36 of wood that is partially impregnated with a cured thermoset material, wherein a substantial amount of that material bled out of the wood during the curing process thus forming a skirt 32 of cured thermoset material exterior to the block 36. It is believed that a large portion, but not all, of the material forming the skirt 32 bled from a top region 34 of the block 36. Accordingly, the block 36 does not have a consistent distribution of cured thermoset material therein and is certainly not fully impregnated. This illustrates what may occur wherein the curing process is not completed fast enough to overcome the bleeding of material from the block as previously described herein. Wherein the block started the curing process fully impregnated and substantially free from skirt material, the missing volume/weight may be calculated by removing the skirt and weighing and/or measuring the volume of the same, such as but not limited to submerging the skirt within a body of water and measuring the volume of water so displaced.

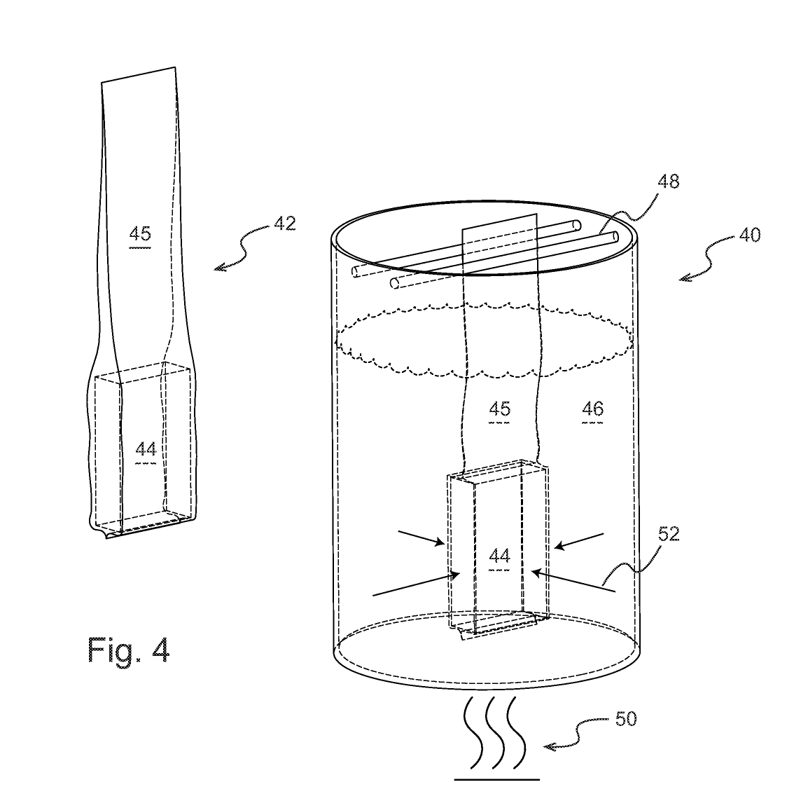

FIG. 4 illustrates a curing tank and associated curing package having a bag and body disposed therein, according to one embodiment of the invention. There is shown a tank 40 having a pair of retaining members 48 configured to beneficially interact (couple to, guide, hold rigid, support, confine, etc. as desired) with a top region of a bag 45 disposed therebetween when the bag is submerged in a fluid bath 46. The bag 45 includes a body disposed therein that, when submerged in the fluid, is subject to increased pressure 52 about substantially all sides thereof. The tank 40 is subject to a heat source 50, such as but not limited to a heating element, furnace, flame, heat pump or the like or combinations thereof. Accordingly, the fluid 46 within the tank 40 is heated thereby and passes that heat to the body 44 disposed within the bag 45. Such may be utilized in a method of curing a thermoset material impregnated body as described herein.

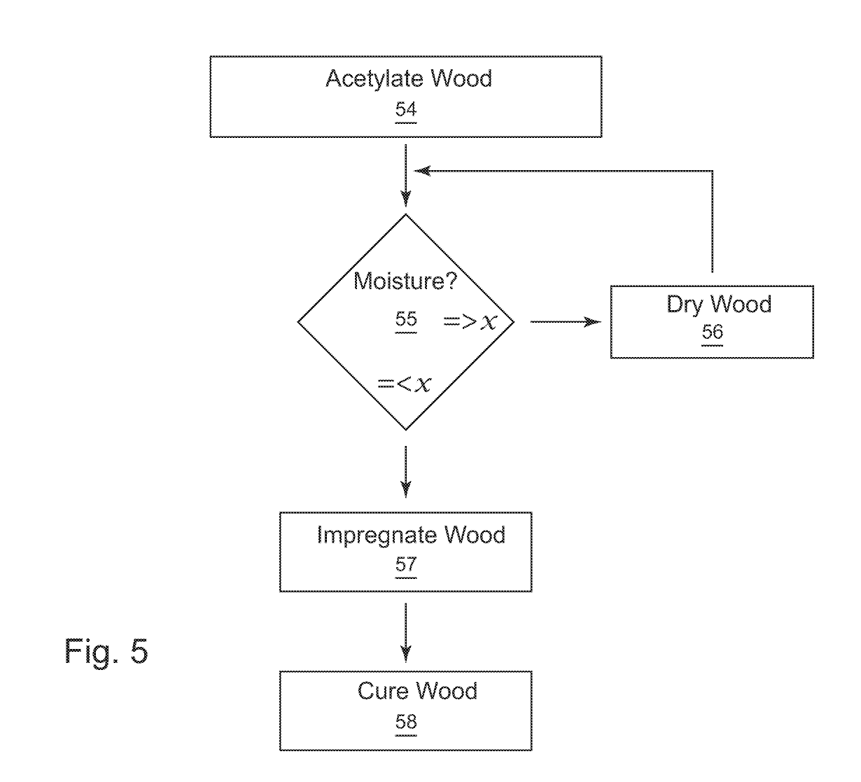

FIG. 5 is a flowchart of a method of manufacturing hardened wood, according to one embodiment of the invention. There is shown a plurality of sequential steps that may be followed in the manufacture of hardened wood that is dimensionally stable.

First, the wood is rendered more dimensionally stable through the process of wood acetylation 54. Generally, the wood is penetrated with acetic anhydride, which replaces free hydroxyl groups within the wood with acetyl groups, thus rendering the wood more dimensionally stable. The acetic anhydride penetrates through the channels and pores of the wood and appears to have a substantial impact on the overall porosity of the wood so treated. Alternatively, the wood may be exposed to other materials which replace the free hydroxyl groups with structures that are similarly neutral to water.

Second, the acetylated wood is dried 56 to a wood moisture content of less than a threshold (x). Applicant has observed a beneficial threshold of moisture content to be below about 10-12%, as moisture content above that level can interfere with subsequent step(s). Moisture content may be measured 55 in various manners, but there are commercially available moisture meters which, usually through measuring resistance, allow one to virtually immediately determine the moisture content thereof. The wood may be dried by exposing it to air that is dry, by baking the moisture out of the wood, by exposing the wood to desiccants (such as but not limited to silica gel, active charcoal, calcium sulfate, calcium chloride, molecular sieves and the like and combinations thereof) and the like and combinations thereof.

Third, the wood is hardened and preserved through the process of impregnating 57 and curing 58 the wood with a liquid thermoset sealant. One may treat the wood with a hardening material, such as but not limited to liquid thermoset sealants/resin/polymer/prepolymer and/or a thermoplastic, such as but not limited to vinyl monomers or similar monomers, modified vinyl monomers and polar monomers (e.g. furfuryl alcohol).

Some examples of vinyl monomers are: vinyl chloride, vinyl acetate, acrylonitrile, ethylene oxide, acrylates (especially methyl methacrylate), t-butyl styrene, styrene and chlorostyrene. Vinyl type monomers may be polymerized into a solid polymer by means of heat, radiation, or heat-catalyst polymerization.

Some examples of thermosetting polymerizable substances include but are not limited to methacrylate esters and diesters, phenol formaldehyde, urea formaldehyde, melamine formaldehyde products, polyurethanes, epoxides, silicones, and unsaturated polyesters. Phenol-formaldehyde resin is located mostly in the cell wall of wood and yields dimensionally stable composites.

Such substances are generally cured by application of energy to the material such as but not limited to by radiation curing, catalyst curing, micro-wave heating, radio-frequency heating, and/or even baking the materials in an oven. This heating hardens the polymer material inside the wood structure and thereby provides enhanced strength from the cross-linked polymers formed inside the interior of the channels of the wood. The process also increases the resistance of the wood to fluid penetration and to attack by insects, molds, etc., though the protection is merely a slowing effect since the effect is caused by physically blocking the channels.

In operation, the liquid thermoset sealant is impregnated into the open cell structure of the wood by use of vacuum and/or pressure, or by simply immersing the wood into a sealant bath and allowing the liquid sealant to replace air within the wood over time. Wherein a vacuum is pulled about the wood, air entrapped therein leaves, which facilitates the impregnation of the wood with the liquid thermoset sealant, as the wood, once the vacuum is reduced/released, draws in the liquid (as the gas has escaped the vicinity of the wood since being released). The impregnated wood is then heated to cure the sealant, which hardens into plastic inside the channels.

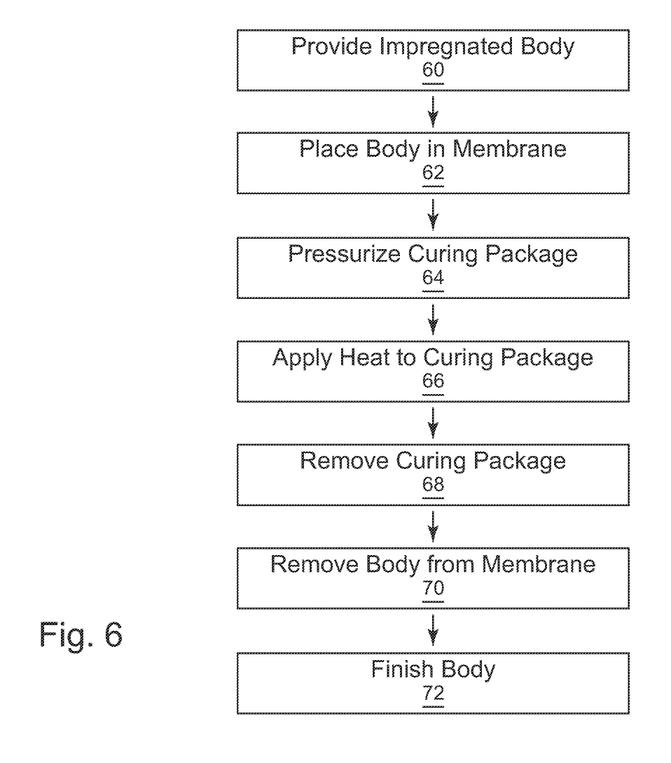

Heat curing requires that the treated wood be exposed to heat over the curing temperature of the thermoset sealant for a time sufficient to cause that same heat to penetrate the wood and cross-link the polymers inside the body of the treated wood. This time will depend on the physical characteristics of the treated wood, the sealant used and the efficacy of the curing oven. Heating the wood too quickly or at too high a temperature risks cracking, splitting, and/or charring the wood. Accordingly, the process must be done at a pace slow enough and at a low enough temperature to prevent such undesired outcomes, but in a manner that prevents the impregnating fluid from escaping before curing, such as but not limited to the method described herein in FIG. 6.

The result is a wood product that is far superior in workability, longevity, density and stability than any of the processes noted above that are practiced alone. This stabilized, hardened, and preserved wood product provides a manufacturing material that can compete with many synthetic and/or metallic materials, while maintaining the beauty and comfort of natural wood. Furthermore, because nearly every cell in the wood is filled with hard plastic, and because the cell walls of the wood are greatly inhibited from swelling, a topical sealant used to repel dirt, oil and water is not required. Furthermore, the wood may be colored throughout with virtually any color by adding a colored dye to the liquid thermoset sealant before impregnation.

FIG. 6 illustrates a method of curing an impregnated body, according to one embodiment of the invention. There is shown a sequential process, though one or more of the illustrated steps may be performed out of the illustrated sequence and/or may be performed simultaneously and/or contemporaneously with one or more of the other illustrated steps.

The first illustrated step is to provide 60 a body that is impregnated with a thermoset material. Such a body is a porous material, generally wood, which has been steeped in a liquid thermoset material, perhaps using vacuum/pressure technique and perhaps having been subject to an acetylation process and/or a drying process. The body may also include one or more other materials impregnated therein, such as but not limited to dyes, insecticides, herbicides, fungicides, UV inhibitors, fragrances, etc.

The second illustrate step is to seal 62 the body in a membrane. This protects the body from undesirable exposure to other materials during subsequent steps and also provides a surface against which the later applied pressure may find purchase to press the membrane against the exterior surface of the body, thereby forming a physical barrier against bleeding of thermoset (or other) impregnated material. The membrane is flexible, shaped and sized such that it may conform to the exterior surface of the body and may wholly enclose the same. The membrane is of a material that, when subject to the pressures, materials, and temperatures described herein to which it will be subject, will continue to perform as desired, including protecting the body from exposure to undesired materials, such as but not limited to steam. The membrane may be sealed by use of heat-sealing, adhesive, or a mechanical closure such as, but not limited to, tongue and groove closures, such as but not limited to the closures used with bag sold under the Ziploc brand. Before the membrane is sealed, a vacuum may be used to evacuate the air inside the membrane, which, combined with the effect of the water pressure, helps to further decrease the rate of sealant bleed-out during the curing process. The combined body and membrane is referred to herein as a curing package.

The third illustrated step is to pressurize 64 the curing package. This may be accomplished through application of physical pressure, such as but not limited to pressing plates against sides of the curing package. However, it may be more easily and fully accomplished by immersing the curing package (at least the portion including the body) in a fluid which has a lower density than the body (or holding the body below the surface of a fluid having a lower density). The fluid then applies pressure to all sides of the curing package. The deeper the submersion the greater the pressure. Wherein the bag is taller than the body, the bag may extend partially out of a fluid bath and any air within the bag may then escape away from around the body as the fluid bath pressure presses against the side thereof. Accordingly, “sealing” the membrane around the body may not require a complete and total seal, but may merely require one sufficient to protect the body from a fluid bath of a particular depth.

Under pressure, the fourth illustrated step of applying heat 66 begins the curing of the thermoset material. As the heat penetrates the body, the material cross-links to form a hardened material with a higher molecular weight and therefore a higher melting point. The changed material solidifies within the body. The heat to be applied must be within the tolerances required by the membrane and other surrounding tools/materials such that the pressure continues to be applied to the body during the heating process.

Once cured, the curing package is removed 68 from the heat and pressure, generally by removing the curing package from the fluid bath, wherein a fluid bath was the source of heat and pressure. The body may be removed 70 from the membrane and then finished 72 according to desired specifications, which may include but is not limited to removing any bleed skirts/residue, polishing, cutting, painting, staining, sanding, machining and the like and combinations thereof.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, while whole wood portions are described herein as being treated, such whole wood portions may be cut, broken, ground, etc. from larger wood portions.

Further, whole a curing method is described that is generally applied to whole wood portions (as being the body) it is understood that the curing process described herein may be applied to non-wood and/or partial wood portions which may be impregnated with thermosetting materials, such as but not limited to impregnated fibrous/porous minerals (asbestos, mica, fiberglass, sandstone, coal, charcoal, fabric, leather, sponge, etc.), and other impregnated porous materials.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A method of manufacturing a hardened wood comprising the steps of acetylating a whole wood portion and impregnating the whole wood portion with a liquid-phase thermosetting polymer.

2. A method of curing a thermosetting polymer impregnated porous body comprising the steps of enclosing the body in a fluid impermeable membrane and subjecting the enclosed body to enhanced fluid pressure as compared to pressure immediately surrounding the body substantially contemporaneously with subjecting the enclosed body interior to the membrane to a temperature sufficient to cure the thermosetting plastic impregnated therein.

3. The method of claim 3, wherein the membrane is a plastic bag and the fluid. pressure and temperature is applied by submerging the enclosed body in water near but below boiling temperature.

4. The method of claim 3, wherein the membrane includes a material selected from the group of materials consisting of silicone, rubber, neoprene, and biaxially-oriented polyethylene terephthalate.
